(19) United States
(12) Patent Application Publication
(10) Pub. No.: US 2012/0069559 A1
(43) Pub. Date: Mar. 22, 2012

(54) LIGHTING MODULE

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/300,623

(22) Filed: Nov. 20, 2011

Related U.S. Application Data
(66) Substitute for application No. 12/888,400, filed on Sep. 22, 2010, now abandoned.

(51) Int. Cl. F21S 8/00

(52) U.S. Cl. 362/227

(57) ABSTRACT

A lighting module includes a plurality of lighting units arranged in a matrix. Positive electrodes of all the lighting units in the first column are connected to form a positive electrode of the lighting module, and negative electrodes of all the lighting units in the last column are connected to form a negative electrode of the lighting module. In any column of the lighting module, negative electrodes of all the lighting units in the odd rows are connected to positive electrodes of all the lighting units in even rows of next column, and negative electrodes of all the lighting units in the even rows are connected to positive electrodes of all the lighting units in odd rows of the next column.

### TECHNICAL FIELD

The disclosure relates to lighting modules, and particularly to a lighting module utilizing a light emitting diode.

### DESCRIPTION OF THE RELATED ART

Light emitting diodes' (LEDs) many advantages, such as high luminosity, low operational voltage, low power consumption, compatibility with integrated circuits, easy driving, long term reliability, and environmental friendliness have promoted their wide use as a light source. Now, light emitting diodes are commonly applied in environmental lighting.

An illumination apparatus often employs a plurality of light emitting diodes connected in series to an external power supply. The external power supply provides operating voltage to the light emitting diodes. However, in the event of an open circuit occurring to a light emitting diode, other light emitting diodes will fail to light due to an absence of current.

Therefore, it is desirable to provide a lighting module which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present lighting module. Moreover, in the drawings, like reference numerals designate corresponding parts throughout the views.

FIG. 1 is a schematic view of a lighting module in accordance with a first embodiment.

FIG. 2 is a schematic view of a lighting module in accordance with a second embodiment.

FIG. 3 is a schematic view of a lighting module in accordance with a third embodiment.

FIG. 4 is a schematic view of a lighting module in accordance with a fourth embodiment.

FIG. 5 is a schematic view of a first lighting apparatus including a plurality of the lighting modules in accordance with the first embodiment.

FIG. 6 is a schematic view of a second lighting apparatus modified from the first lighting apparatus of FIG. 5.

FIG. 7 is a schematic view of a third lighting apparatus modified from the second lighting apparatus of FIG. 6.

### DETAILED DESCRIPTION

Embodiments of a lighting module as disclosed are described in detail here with reference to the drawings.

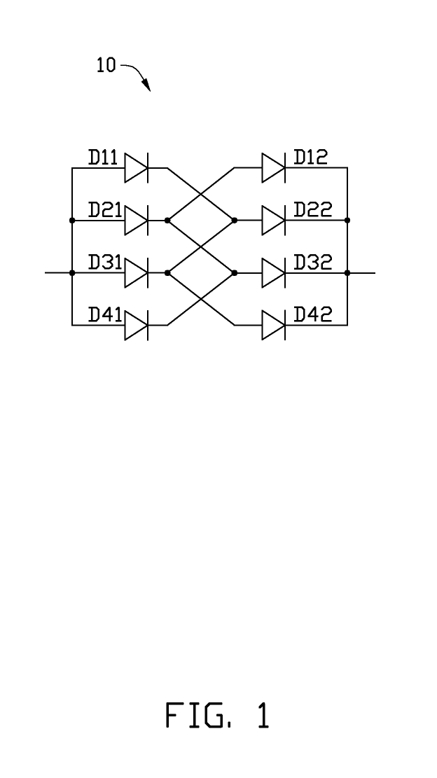

Referring to FIG. 1, a lighting module 10 includes eight lighting units D11, D21, D31, D41, D12, D22, D32, and D42 arranging in a matrix. Here, the eight lighting units are arranged in four rows and two columns. The lighting units D11, D21, D31, and D41 are arranged in four rows of the first column. The lighting units D12, D22, D32, and D42 are arranged in four rows of the second column. The lighting units are lighting emitting diodes.

The positive electrodes of the four lighting units D11, D21, D31, and D41 of the first column connect together and form the positive electrode of the lighting module 10. The negative electrodes of the four lighting units in the second column D12, D22, D32, and D42 connect together and form the negative electrode of the lighting module 10. The negative electrodes of the lighting units D11 and D31 in the odd rows of the first column are electrically connecting to the positive electrodes of the lighting units D22 and D42 in the even rows of the second column. The negative electrodes of the lighting units D21 and D41 in the even rows of the first column are electrically connecting to the positive electrodes of the lighting units D12 and D32 in the odd rows of the second column.

When applying a driving voltage or driving current between the positive electrode and negative electrode of the lighting modules 10, all the lighting units of the lighting module 10 will be turned on.

When one of the lighting units, for example D11, forms an open circuit, the current flows through the lighting unit D31. Thus, the lighting units D22 and D42 will still be turned on. Moreover, the lighting units D21, D41, D12, D32 are also not affected by the open circuit of the D11.

When one of the lighting units, for example D11, forms a short circuit, the positive and negative electrodes of the lighting unit D31 will be shortly conducted. The D31 can not be turned on but the lighting units D22 and D42 can still be turned on. Furthermore, the lighting units D21, D41, D12, and D32 will still normally be turned on.

Whether the lighting unit D11 forms an open circuit or a short circuit, it does not affect the normal operation of adjacent lighting units D21 and D22. Thus, the arrangement of the lighting units can handle the problem that when one lighting unit short circuit, breaks down and then the other lighting units of the same column or the same row will not function normally.

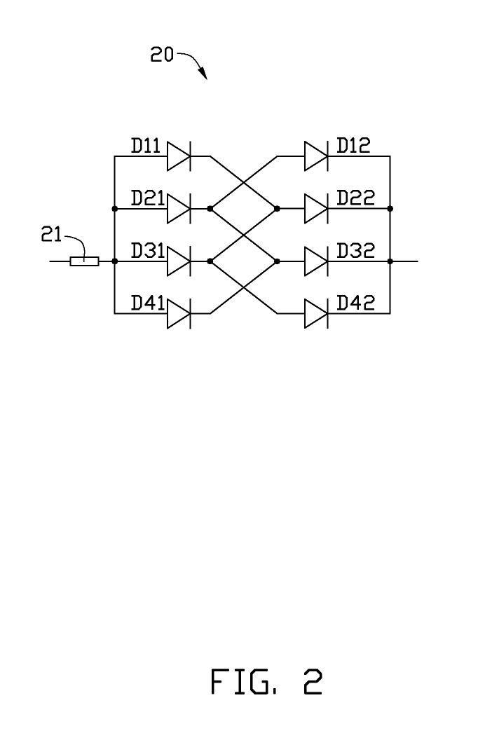

Furthermore, the lighting module can also include a resistor to control the current flowing through the lighting units. Referring to FIG. 2, a lighting module 20 in accordance with a second embodiment further includes a resistor 21, the resistor 21 and the lighting module 10 connect in series; the circuit can control the current of lighting units of the lighting module 20. That can control the illumination intensity of the lighting module 20.

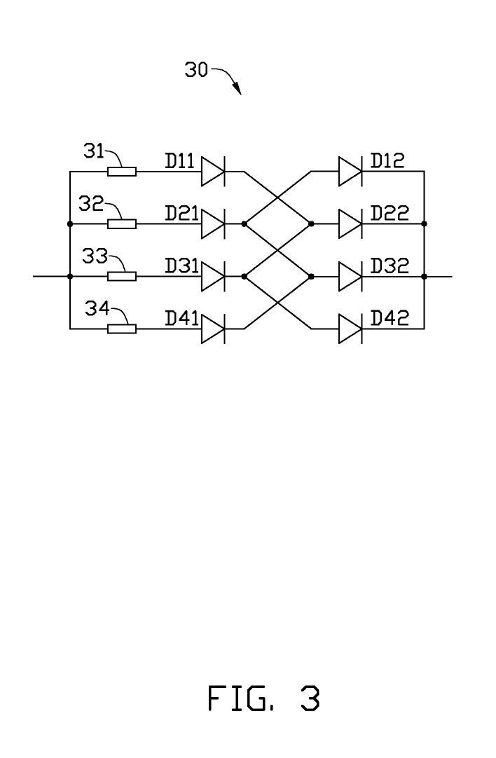

Besides, the location of resistor is not limited to the way shown in this embodiment. Referring to FIG. 3, a lighting module 30 in accordance with a third embodiment further includes four resistors 31, 32, 33, and 34. The one end of each of the resistors 31, 32, 33, and 34 connects in series to the positive electrode of a corresponding one of the four lighting units D11, D21, D31, and D41. The other one end of each of the resistors 31, 32, 33, and 34 connecting together forms the positive electrode of the lighting module 30.

The resistors 31, 32, 33, and 34 above mentioned can also be arranged to form the negative electrode of the lighting module as long as they can tune the currents of the lighting units effectively.

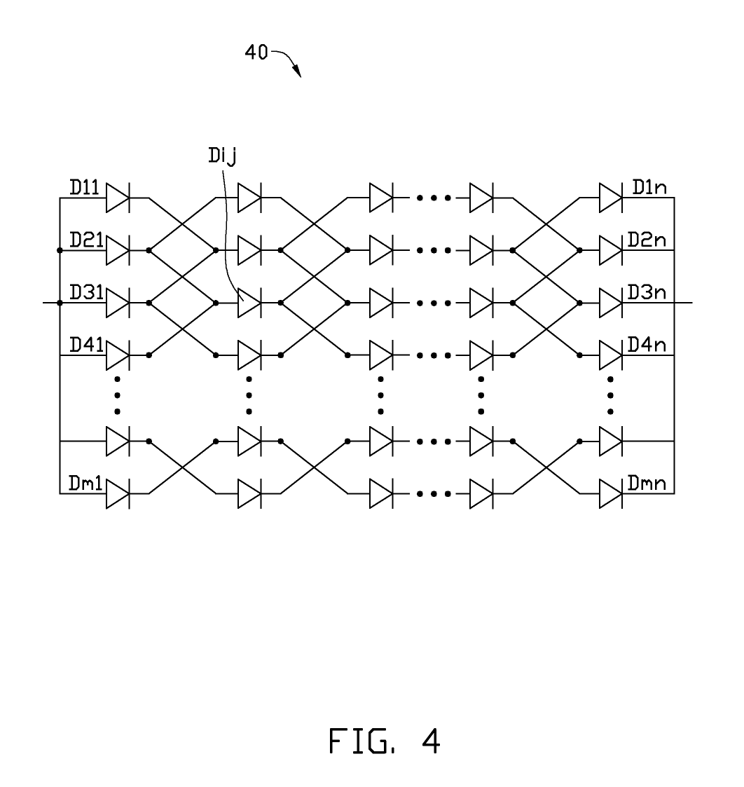

Referring to FIG. 4, the lighting module 40 includes an array of lighting units, and the lighting units array in m rows and n columns. The positive electrodes of the lighting units of the first column connecting to each other form the positive electrode of the lighting module 40. The negative electrodes of the lighting units of the last column connecting to each other form the negative electrode of the lighting module 40.

In this embodiment, the symbol of the Dij represents the lighting unit locating at i row and j column whereby the i is an integer not exceeding the m and j is an integer less than the n. The negative electrodes of the lighting units in the odd rows of j column electrically connect to the positive electrodes of the lighting units in the even rows of the j+1 column. The negative electrodes of the lighting units in the even rows of j column electrically connect to the positive electrodes of the lighting units in the odd rows of the j+1 column. Thus, when one of the lighting units breaks down, it does not affect the normal operation of adjacent lighting units.

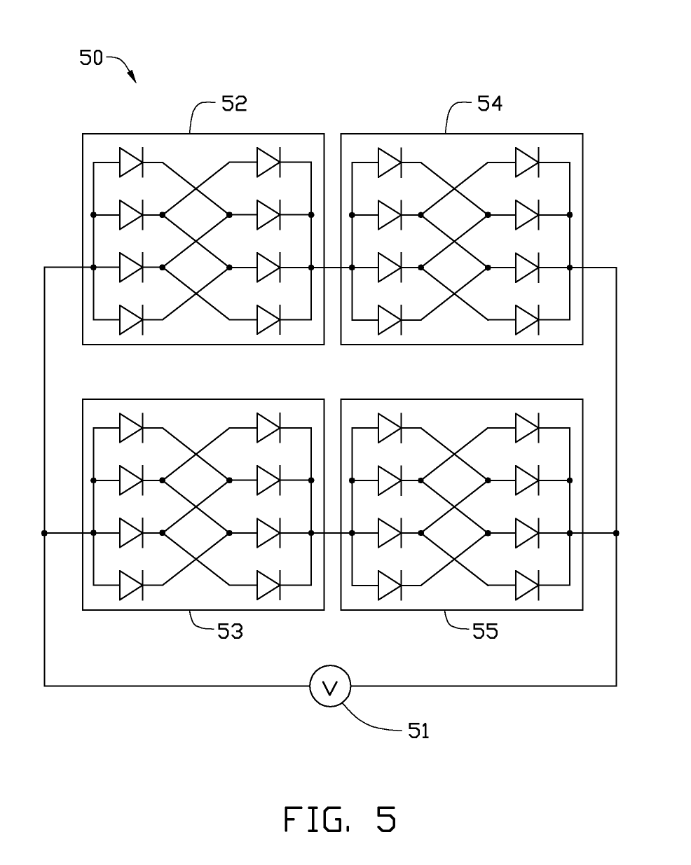

A plurality of the lighting modules can be combined together to form a lighting apparatus 50. Referring to FIG. 5, the lighting apparatus 50 includes a power source 51 and four lighting modules 52, 53, 54, and 55 arranged between the positive and negative electrodes of the power source 51. Each of the four lighting modules 52, 53, 54, and 55 is the same with the lighting module 10 and arranged in a matrix. The lighting modules 52 and 53 are respectively in the first row and the second row of the first column, and the lighting modules 54 and 55 are respectively in the first row and the second row of the second column. The lighting module 52 and the lighting module 54 form a series branch of circuit. The lighting module 53 and the lighting module 55 form a series branch of circuit. The two branches connect in parallel and connect to the power source 51 between the positive and negative electrodes thereof.

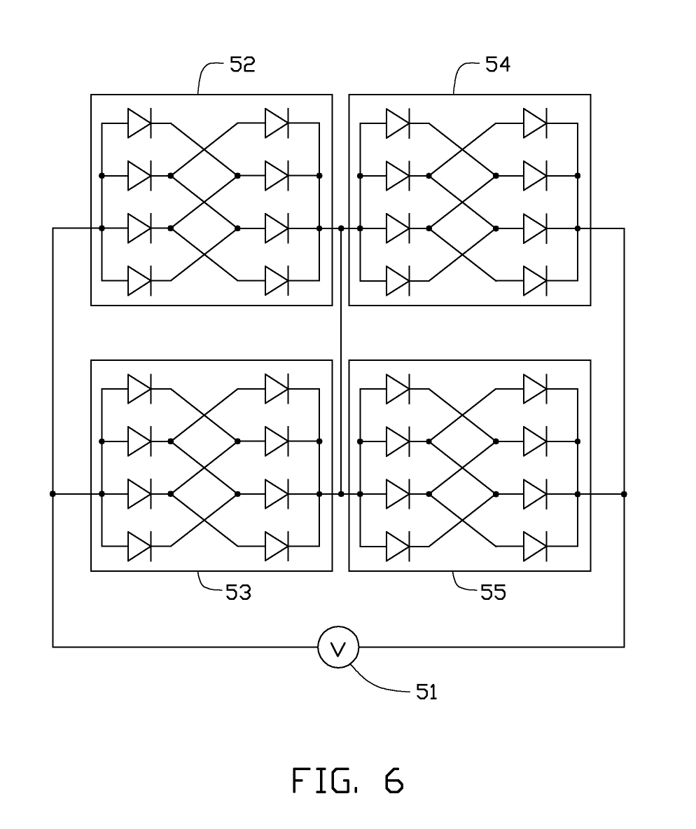

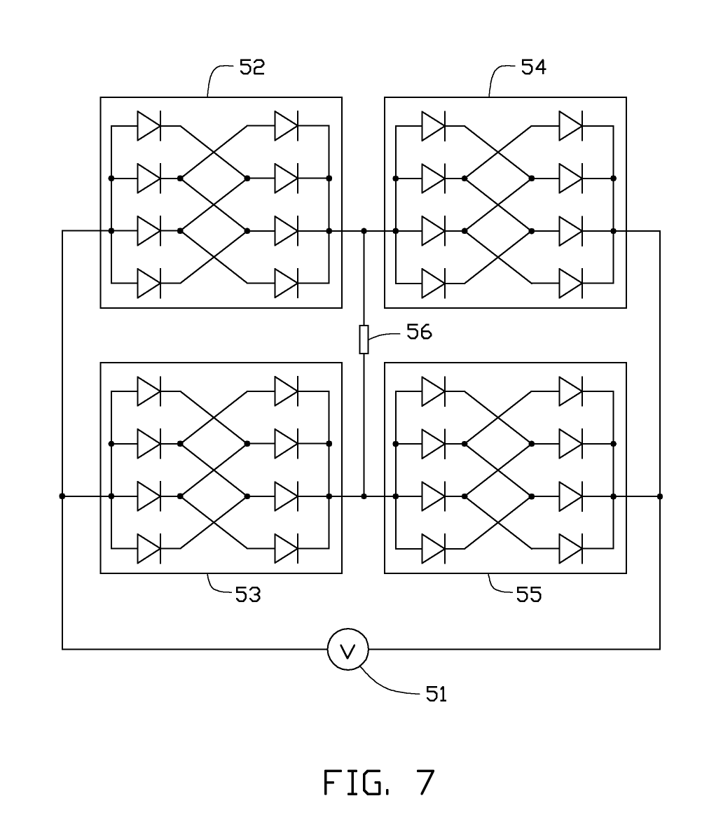

The configuration of lighting apparatus is not limited to the way shown in above mentioned embodiment. Referring to FIG. 6, the negative electrodes of the lighting module 52 and the lighting module 53 connect together by a connecting wire. According to what it needs, the connecting wire of the negative electrodes of the lighting module 52 and the lighting module 53 can be inserted with a resistor 56, as shown in FIG. 7.

For the configuration of lighting apparatus mentioned above, the damage of any lighting unit does not affect the normal operation of the adjacent lighting units.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lighting module, comprising a plurality of lighting units arranged in a matrix comprising m rows and n columns, wherein each of m and n is an integer exceeding one, the connected positive electrodes of the lighting units of the first column form the positive electrode of the lighting module, and the connected negative electrodes of the lighting units of the last column form the negative electrode of the lighting module, and wherein the negative electrodes of the lighting units in the odd rows of j column electrically connect to the positive electrode of the lighting units in the even rows of the j+1 column, the negative electrodes of the lighting units in the even rows of j column electrically connect to the positive electrodes of the lighting units in the odd rows of the j+1 column, and j is an integer less than n.

2. The lighting module of claim 1, wherein the lighting module further includes a resistor connecting to the plurality of lighting units in series.

3. The lighting module of claim 1, wherein the lighting module further includes a plurality of resistors connecting separately to the positive electrodes of the lighting units of the first column in series.

4. The lighting module of claim 1, wherein each of the lighting units is a light emitting diode.

5. A lighting apparatus, comprising a power supply and a plurality of lighting modules arranged in a matrix including a plurality of columns and rows, and the lighting modules in the same row form a series branch of circuit, and the series branches of circuit of different rows connect in parallel and to the power supply, each lighting module comprising a plurality of lighting units arranged in a matrix comprising m rows and n columns, wherein each of m and n is an integer exceeding one, the connected positive electrodes of the lighting units of the first column form the positive electrode of the lighting module, and the connected negative electrodes of the lighting units of the last column form the negative electrode of the lighting module, and wherein the negative electrodes of the lighting units in the odd rows of j column electrically connect to the positive electrode of the lighting units in the even rows of the j+1 column, the negative electrodes of the lighting units in the even rows of j column electrically connect to the positive electrodes of the lighting units in the odd rows of the j+1 column, and j is an integer less than n.

6. The lighting apparatus of claim 5, wherein the negative electrodes of the lighting modules of the same column are connected together via a wire.

7. The lighting apparatus of claim 6, wherein a resistor is inserted into the wire.
